(19) United States
(12) Patent Application Publication
(10) Pub. No.: US 2006/0162849 A1
(43) Pub. Date: Jul. 27, 2006

(54) Method of joining ceramics: reaction diffusion-bonding

(76) Inventor: Joo-Hwan Han, Kyungsangbuk-do (KR)

Correspondence Address: LADAS & PARRY LLP, 224 SOUTH MICHIGAN AVENUE, SUITE 1600, CHICAGO, IL, 60604, US

(21) Appl. No.: 10/560,219

(22) PCT Filed: May 28, 2004
(86) PCT No.: PCT/KR04/01265

§ 371 Date: Dec. 9, 2005

(30) Foreign Application Priority Data
Jun. 13, 2003 (KR) 10-2003-0038376
Oct. 29, 2003 (KR) 10-2003-0075798

(51) Int. Cl. B32B 37/00; C04B 37/00

(52) U.S. Cl. 156/153; 156/272.2; 156/325

(57) ABSTRACT

Provided is a method of joining compound materials such as ceramics. The method is a combination of diffusion bonding and reaction bonding, which is called reaction diffusion bonding (RDB). The method includes: grinding, lapping, or polishing entire or portions of surfaces to be joined of two or more pieces of a compound material; forming a thin film of a joining agent on one or more of the ground, lapped, or polished surfaces by one of inserting, spreading, depositing, plating, and coating, the joining agent being able to transform into the compound material by being incorporated into the compound material or by forming a solid solution with the compound material upon heat treating; and forming a directly bonded interface without a second phase by heat treating the pieces of the compound material with the to-be-joined surfaces on which the joining agent film is formed arranged to face each other, wherein the joining agent thin film is composed of a material selected from the group consisting of metals, metal organics, and metal compounds.

### TECHNICAL FIELD

The present invention relates to a method of joining materials, and more particularly, to a method of joining compound materials such as ceramics.

### BACKGROUND ART

Excellent properties of ceramics, such as high temperature resistance, extreme hardness, high chemical resistance and lower density than metals, are the reason for the application of technical ceramics in the vast fields of electronics, automotive industry, aerospace, chemical industry and so on. However, industrial products are very rarely monolithic. The problem of joining components is therefore a key issue in the design process. There are at least two reasons for joining ceramics: to assemble a complex structure from single components of the same material, or to join dissimilar materials so that the properties of various materials contribute to the design.

Joining ceramics enables us to obtain morphologies that may not otherwise be practical or even feasible. One of the most important functions of joining techniques is to provide the means for economic fabrication of complex, multi-component structures. Many complex joining techniques have been developed for ceramic-to-metal and ceramic-to-ceramic joining, and they can probably be classified into two groups: joining with and without the use of an interlayer. The former includes adhesive bonding, brazing/soldering, and glass frit joining, and the latter includes mechanical fastening, co-sintering, diffusion welding (also called diffusion bonding), and fusion and friction welding.

However, metal brazing, glass frit bonding, and adhesive bonding principally reduce the thermal and chemical stability of the ceramic system. These disadvantages originate from the presence of an additional material (glue or solder) with completely different properties from those of the ceramics. Therefore, a critical weak point is generated at the joint. Furthermore, mechanical fastening is frequently inadequate because ceramic parts are inherently brittle, and fusion welding by laser or an electron beam cannot be widely applied to the joining of ceramics because of incompatibilities due to excess localized stresses which cannot be accommodated by a stiff material and the possible thermal decomposition of the ceramics during the welding process.

The co-sintering process for joining ceramics is also successful only in some limited systems because of the difficulties in handling components to be joined, due to their weak mechanical strengths. In the diffusion bonding process, bonding occurs through plastic deformation and solid-state diffusion across the interface. Ideally, the process conditions produce plastic deformation locally at the joint surfaces that allows creep and diffusion to seal the interface and produce a bond. However, most ceramic materials do not readily deform and the diffusion process is rather slow except at extremely high temperatures, and thus rarely successful. It has been reported that only ˜25% of the interface area is joined by diffusion bonding of sapphire.

Currently no technology exists that, within reasonable economical limits, produces joints of satisfactory quality between ceramic parts and preserves the excellent properties of the ceramic material. The lack of a well-developed joining technology for ceramics limits or prevents the use of ceramics in a range of applications. The problems associated with joining ceramics for high temperature applications are particularly severe. Innovative approaches to joining ceramic materials that minimize deleterious chemical interactions are required. The present invention pursues to develop and apply unconventional approaches to ceramic-ceramic joining. For joining ceramic crystals without deteriorating the mechanical, chemical, thermal, and optical properties, we have developed a new method combining diffusion bonding and reaction bonding.

An example of making a monolithic ceramic part is a joining of sapphire panes for large-area window applications. Single crystal aluminum oxides (Sapphire-Al₂O₃) are currently used as the window material in the visible, near infrared and ultraviolet spectrum ranges due to their combinations of excellent optical quality, high strength and resistances to erosion and thermal shock. Their high thermal conductivity provides an excellent thermal shock resistance more than other window materials available such as spinel, yttria, ALON (Aluminum Oxynitride). In addition, they provide effective ballistic protection. The major limitation of sapphire for use in window and ballistic protection applications is that it cannot be produced in a size large enough to meet some proposed system requirements. Scaling current sapphire crystal growth processes to produce the desired window sizes is cost prohibitive and technically risky; and growing high quality, homogeneous crystals in much larger diameters may have intrinsic limitations.

A method of joining smaller sapphire panes into a suitably strong, optically transparent, large area window is therefore required to circumvent these limitations. Additionally, the complex shaped sapphire components required in fields such as aerospace or energy can also be formed by joining simpler shaped sapphire components. Once conventional adhesives are not able to withstand the high temperatures and stresses encountered during in-service, other methods of achieving a suitable bond have been investigated. The techniques developed for sapphire joining include frit bonding, brazing, and diffusion bonding.

A method of joining sapphire that can provide relatively favorable optical characteristics and joint strength is disclosed in U.S. Pat. No. 5,942,343. In the method, surfaces of sapphire panes are coated with MgO (magnesia) vapor, and the sapphire pieces heat-treated after the magnesia-coated surfaces are arranged to contact each other in the presence of a hydrogen-containing gas at a temperature of 1500˜2000° C. for several hours. However, this method does not provide sufficient direct bonding between the sapphires due to the formation of a MgAl₂O₄ spinel phase between the coated MgO and the sapphire at the joining interface during heat treatment.

### DISCLOSURE OF INVENTION

Technical Problem

There is need for a method of joining individual pieces of ceramic materials (including single crystal, poly-crystal, and amorphous material) into a directly bonded one-body structure without leaving an intermediate layer phase.

Technical Solution

The present invention provides a method of joining individual pieces of ceramic materials (including single crystal, poly-crystal, and amorphous material) into a directly bonded one-body structure having a large size and complicated shape through a chemical reaction at the joining interface without leaving an intermediate layer phase.

According to an aspect of the present invention, entire or portions of surfaces of two or more pieces of a ceramic material are ground, lapped, or polished. A thin film is formed on the surfaces to be joined by inserting, spreading, depositing, plating, or coating a joining agent. The joining agent promotes material transport at the joining interface thereby providing a way other than plastic deformation, to smoothen asperities and resulting in intimate mating surfaces, which is required for diffusion bonding. Conventionally, a number of joining agent materials have been proposed for diffusion bonding of ceramics. However, all of these efforts have only been partly successful in manufacturing ceramic part assemblies by diffusion bonding because of the degradation in properties of the assemblies due to the presence of second phases existing in an intermediate layer between the ceramic materials. The composition of joining agents that have been used in ceramics joining were not similar to that of the ceramics to be joined. One of the key aspects of this invention is a careful selection of the joining agent. In order to achieve a direct bonding of ceramic materials at the joining interface, a joining agent should be selected such that it will be completely exhausted during the joining process by its incorporation into the parent ceramic materials, resulting in no residual phase existing after the completion of joining. The joining agent for this purpose includes the metals, metal organics, metallic compounds, or a mixture or solution of them containing the metallic elements that can be incorporated into the ceramic material or can form a solid solution with the ceramic material through a chemical reaction with the ceramic material and/or an atmospheric gas during heat treatment.

Afterward, the pieces are arranged so that a surface having the agent thin film and a surface without the agent thin film, or two surfaces having the agent thin films face each other. Then, the pieces are heat-treated at a high temperature under an externally applied pressure or atmospheric pressure, in the atmosphere of air or vacuum, or in the presence of an inert gas, a hydrogen containing gas, or a gas containing the non-metallic element constituting the ceramics to be joined. Thus, the ceramic materials are joined without a second phase at the joined interface because of a chemical reaction involving the joining agent and the joining agent's exhaustion by incorporation into and/or formation of a solid solution with the parent materials (ceramics to be joined). To improve characteristics of the joined assembly, a second heat treatment in the presence of one of the above-mentioned gases can be performed.

The joining agent thin film is formed on the surface to be joined by insertion of a foil, coating a slurry or paste, or by a thin film production process. The joining agent comprises more than one metallic element that can be incorporated into or is soluble in the parent materials during heat-treatment, and can be in the form of metals, metal organics, metallic compounds, or a mixture or solution of these. The metallic element is selected from the group consisting of Li, Be, B, C, Na, Mg, Al, Si, K, Ca, Sc, Ti, V, Cr, Mn, Fe, Co, N, Cu, Zn, Ga, Ge, As, Se, Rb, Sr, Y, Zr, Nb, Mo, Tc, Ru, Rh, Pd, Ag, Cd, In, Sn, Sb, Te, Cs, Ba, Hf, Ta, W, Re, Os, Ir, Pt, Au, Hg, Ti, Pb, Bi, Po, Fr, Ra, La, Ce, Pr, Nd, Pm, Sm, Eu, Gd, Tb, Dy, Ho, Er, Tm, Yb, Lu, Ac, Th, Pa, U, Np, Pu, Am, and Cm.

On the other hand, uniaxial pressing at a relatively high temperature (hot-pressing) has been widely used to produce butt joints by diffusion bonding metal components already machined to their final shape and dimensions, and prepared with smooth and flat mating surfaces. The diffusion bonding requires no localized melting of components or introduction of foreign bonding materials but merely that mating surfaces are brought into close, atomic scale contact so that an interface can be formed by inter-diffusion to create a structural continuum. Such bonding usually occurs through a two-step process; the initial formation of contact area and the subsequent joint formation by the growth of bonded interfaces. The initial contact is achieved by an instantaneous plastic deformation or creep, due to the externally applied pressure, of the asperities (peaks) of contacting surface features. The driving forces for the subsequent growth of the bonded neck areas and shrinkage of the isolated voids are the accommodation of the externally applied pressure and the reduction in the total surface energy of the system caused by the interface formation.

The plasticity of ceramics is, however, generally so poor that deformation of asperities to obtain an initial contact and conformity of the mating surfaces is seldom possible. Furthermore, the refractoriness of ceramics causes the fabrication temperatures to often be unacceptably high for the equipment that is available. In this respect, a new way to enhance the deformation of asperities other than plastic deformation is required. In the present invention, a thin joining agent film having a thickness in a range of 0.001-500 μm, possibly 1-10 μm which contains the metallic element that can be incorporated into the parent material, is formed on the surfaces to be joined. When the pieces of the ceramics with the coated surfaces are heat-treated in contact with each other at a temperature above the melting point (including a partial melting point) of the joining agent, the thin film forms a liquid in an early stage of the joining process. A m olten joining agent used in this invention is believed to deform the asperities on the mating surfaces and to form intimate mating surfaces by a solution and re-precipitation process facilitated by the applied pressure. By wetting the parent materials and with the aid of an applied pressure, the liquid phase, i.e. the molten agent, can dissolve the parent materials or smoothen asperities, resulting in intimate mating surfaces.

However, as disclosed herein, no trace of joining agent in the joined specimen implies that the liquid agent between the ceramics transforms into the ceramics and/or partly evaporates during heat-treatment. Equilibrium partial pressure of oxygen for the oxidation reaction of Al (joining agent for sapphire, for example) at 1500° C. is estimated to be around 10⁻²³ atm. The partial pressure of oxygen during the heat-treatment, on the other hand, is evaluated to be 4*10⁻⁵ atm, from the purity of the Ar gas used in the joining process. Therefore, the liquid Al is believed to be oxidized during heat-treatment by the oxygen gas dissolved into the liquid melt. The oxidized

Al molecules (Al₂O₃), formed in the melt, are likely to move to the sapphire-melt interfaces and then be incorporated into the sapphire structure. The facets observed at the joined interface region in the high-resolution TEM image are strong evidence of the presence of a temporary Al-rich liquid phase at an early stage of the joining process. Such processes may proceed continuously until the exhaustion of Al melt. As a result, the ceramic-to-ceramic (sapphire-to-sapphire) direct bonding is achieved without leaving a second phase in the joined interface.

Advantageous Effects

Accordingly, individual pieces of ceramic materials can be directly bonded to form a large-sized one-body structure through the joining process according to an embodiment of the present invention. This reaction diffusion-bonded ceramics structure has suitable characteristics for application to practical fields because it possesses almost the same mechanical, optical, electrical and electronic, electromagnetic, thermal, chemical, and crystallographic characteristic as the individual pieces of the parent materials, and maintains the structural integrity of the materials. A method of reaction joining according to an embodiment of the present invention can be used to overcome the drawbacks and difficulties of the conventional methods of joining, and the ceramic parts joined according to embodiments of the present invent ion has various advantages such as superior thermal, mechanical, chemical, electrical and electronic, and electromagnetic characteristics compared to the parts prepared by a conventional method.

### DESCRIPTION OF DRAWINGS

FIG. 1 is a flowchart illustrating a method of joining ceramic materials according to an embodiment of the present invention;

FIG. 2A is a photograph of a sapphire crystals joined using Al as a joining agent according to an embodiment of the present invention;

FIG. 2B is a SEM image of the interface region of the reaction diffusion-bonded sapphire crystals in FIG. 2A;

FIG. 2C is an optical transmittance measured across the interface of the joined sapphire crystals in FIG. 2A;

FIG. 3 is a photograph of the sapphire crystals joined using an aluminum foil as a joining agent according to an embodiment of the present invention;

FIG. 4A is a photograph of the alumina ceramics joined using Al as a joining agent according to an embodiment of the present invention;

FIG. 4B is a SEM image of the interface region of the joined alumina ceramics in FIG. 4A;

FIG. 5A is a photograph of the MgO single crystals joined using Mg as a joining agent according to an embodiment of the present invention;

FIG. 5B is a SEM image of the interface region of the joined MgO single crystals in FIG. 5A;

FIG. 6 is a photograph of the ZnS poly-crystals joined using Zn as a joining agent according to an embodiment of the present invention;

FIG. 7A is a photograph of the soda-lime glass joined using Al as a joining agent according to an embodiment of the present invention;

FIG. 7B is a SEM image of the interface region of the joined soda-lime glass in FIG. 7A;

FIG. 8 is a SEM image of the interface region of AlN ceramics joined using Al as a joining agent according to an embodiment of the present invention;

FIG. 9 is a SEM image of the interface region of Si₃N₄ ceramics joined using Si as a joining agent according to an embodiment of the present invention;

FIG. 10 is an SEM image of the interface region of SiC ceramics joined using Si as a joining agent according to an embodiment of the present invention; and

FIG. 11 is a SEM image of the interface region of quartz glass joined using Si as a joining agent according to an embodiment of the present invention.

### BEST MODE

The present invention will now be described more fully with reference to the accompanying drawings in which exemplary embodiment of the present invention are shown. This invention may, however, be embodied in many different forms and should not be construed as being limited to the embodiments set forth herein. Rather, these embodiments are provided so that this disclosure will be thorough and complete and fully convey the concept of the invention to those skilled in the art. The following detailed description is, therefore, not to be taken in a limiting sense, and the scope of the present invention is defined only by the appended claims.

Particularly, in the present invention, a crystal denotes not only a pure crystal, its solid solutions or composites, but also a single crystal and a poly-crystal. In this disclosure, reference is made mainly to crystal pieces and joining thereof, but those skilled in the art could apply the embodiments of the present invention to joining a crystal and its solid solution (or composite) crystal and joining solid solution (or composite) crystals. The present invention can also be applied to joining a crystal and an amorphous material and joining amorphous materials.

### EMBODIMENTS

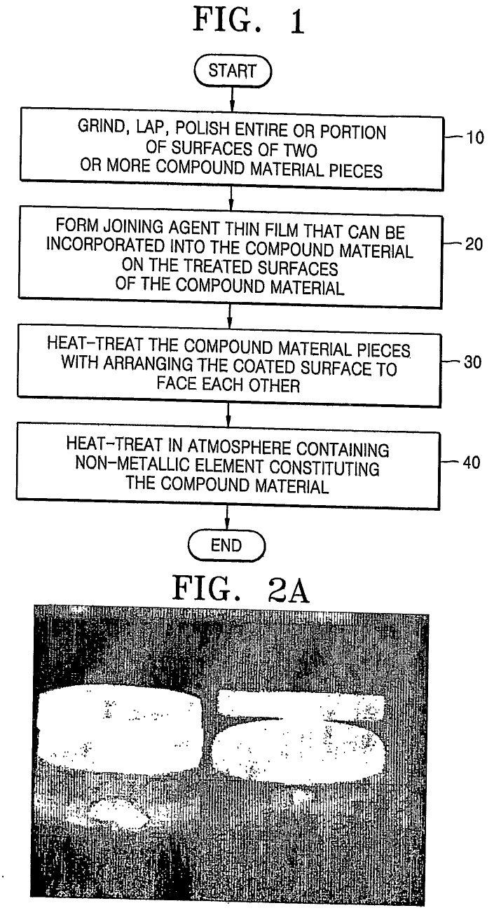

FIG. 1 is a flowchart illustrating a method of joining ceramics according to an embodiment of the present invention.

Referring to FIG. 1, in step 10, surfaces of more than two pieces of ceramic material (the material may be a single crystal, a poly-crystal, a single crystal solid solution, a poly-crystal solid solution, or an amorphous material) are totally or partly ground (or lapped or polished). The pieces of the material can be crystal pieces cut according to crystallographic orientation, size, and shape from a manufactured crystal, a solid solution thereof, or a composite crystal.

In step 20, joining agent thin films are formed on more than one ground (or lapped, or polished) surface of the pieces to be joined. The agent thin films are composed of metals, metal organics, metallic compounds, or a mixture or solution thereof, containing metallic elements that can transform and incorporate into the parent ceramic material or can form a solid solution through a chemical reaction with the material and/or an atmospheric gas during heat treatment. The film can be formed by inserting a foil between two adjacent pieces of the material; coating the metals, metal organics, metallic compounds, or a mixture or solution of thereof in a slurry or paste state in which fine particles having nm-scale sizes are dispersed; and one of depositing, plating, and coating the metals, metal organics, or metal impounds on the surfaces to be joined using a method selected from the group consisting of a spin coating method, a sol-gel method, a sputtering method, a chemical vapor deposition (CVD) method, a metal organic CVD method, a laser ablation method, a pulsed laser deposition method, a reactive evaporation method, and a plating method (including electroless plating).

The metallic elements that can transform and incorporate into the ceramic material or form a solid solution with through a chemical reaction during heat treatment are Li, Be, B, C, Na, Mg, Al, Si, K, Ca, Sc, Ti, V, Cr, Mn, Fe, Co, Ni, Cu, Zn, Ga, Ge, As, Se, Rb, Sr, Y, Zr, Nb, Mo, Tc, Ru, Rh, Pd, Ag, Cd, In, Sn, Sb, Te, Cs, Ba, Hf, Ta, W, Re, Os, Ir, Pt, Au, Hg, Tl, Pb, Bi, Po, Fr, Ra, La, Ce, Pr, Nd, Pm, Sm, Eu, Gd, Th, Dy, Ho, Er, Tm, Yb, Lu, Ac, Th, Pa, U, Np, Pu, Am, and Cm. These metals can be used in the form of the pure metals themselves, metal organics, or metallic compounds. Ceramic materials that can be joined using the present invention include borides, carbides, nitrides, oxides, fluorides, silicides, phosphides, sulfides, chlorides, germanides, arsenides, selenides, bromides, tellurides, iodides, inter-metallic compounds, and composites and solid solutions of these compounds.

Referring to FIG. 1, in step 30, the pieces are arranged such that a surface having the thin film and a surface without the thin film, or two surfaces having the thin film face each other. Then, the arranged pieces are heat-treated at a high temperature in air or a vacuum, or in the presence of an inert gas, hydrogen containing gas, or a gas including the non-metallic element constituting the parent material. The heat treatment may or may not be performed under an applied pressure. The heat treatment can be performed between the melting point (including a partial melting point) of the joining agent and the boiling temperature of the agent for from approximately 1 minute to 10 hours. The applied pressure is in a range of 0˜100 MPa, and can be 0˜10 MPa. Heat treatment methods include radiant heating, inductive heating, microwave heating, ultrasonic heating, and the like. The joining agent thin film formed on the ground (or lapped or polished) surfaces of the ceramic material performs as a temporary intermediary layer for promoting migration of material at the interface during heat treatment, and incorporates into the ceramic material or forms a solid solution through a chemical reaction with the parent material and/or the non-metallic element in the atmosphere gas. Finally, by continuing this process until the joining agent is exhausted from the interface, the monolithically joined ceramic parts having uniform mechanical, chemical, optical, electrical and electronic, and electromagnetic characteristics and thermal expansion coefficient that are almost identical to those of the parent material can be obtained. Thus, a large monolithic structure of ceramic materials having mechanical and structural integrity can be produced because the interface has strong chemical bonding. The joined interface can form a directly bonded interface without a second phase, i.e., the amount of material in the second phase is below a measurable limit. However, even if there exists material in a second phase in the interface, the material in the second phase may not be in the form of a film having a uniform thickness but may be in the form of a precipitate or a segregate because of the very thin joining agent layer.

To complete a phase change of the joining agent during the joining process, adequate control of the atmospheric gas is important, but control of the thickness of the agent film is particularly important. When the film is thick, it takes many hours to complete the phase change of the joining agent film because the process of phase change requires a diffusion of gas into the film and a chemical reaction. Also, there is a risk of an interlayer of unreacted joining agent material remaining in the interface. On the other hand, when the thickness of the film is too thin, a desired joint strength can not be obtained. Accordingly, the thickness of the film must be adequate. The thickness of the metallic thin film is in a range of 0.001-500 μm and may be 0.1-10 μm and depends on both the roughness of the surfaces to be joined and the reaction characteristics between the parent ceramic materials and the joining agent

Heat treatment for joining can be performed while applying an electric field to the ceramic materials. Ceramic materials are formed with covalent bonds or ionic bonds, and a majority of them are formed with ionic bonds. When an external electric field is applied to an ionic material, positive and negative ions of the material are respectively influenced in opposite directions by the applied field, resulting in electro-migration. This phenomenon can be utilized for material joining. For example, when a voltage is applied to the external surfaces of the pieces while performing heat treatment after contacting two material pieces to be joined, positive ions migrate toward the joining interface from an area where the positive voltage is applied, and negative ions migrate toward the joining interface from where the negative voltage is applied. As a result of this electro-migration, the positive and negative ions are supplied from the parent material to the interface region at which the ions recombine to form molecules and to fill the spaces between two pieces, thereby facilitating bonding of the two pieces. When applying an electric field, the electrical conductivity during the heat treatment and the thickness of the material to be joined should be taken into consideration. A voltage in a range of 0 to 5 KV can be applied, and the voltage may be 0 to 0.5 KV.

If the joining process according to the above embodiment of the present invention cannot be applied because a joining agent has a higher melting point than that of the parent material, or if there is a possibility of thermal decomposition or phase change of the agent material during heat treatment, a heat treatment step can be performed before the joining heat-treatment step such that a phase change and/or thermal decomposition of the joining agent material occurs in advance, thus resulting in another phase of joining agent material having a lower melting temperature than the parent material. This further treatment is performed at a temperature below the melting point of the thin film in air or vacuum % or in the presence of an inert gas, hydrogen-containing gas, or in a reduction-inducing atmosphere.

In step 40, which is an optional step, an additional heat treatment in the presence of a gas containing non-metallic elements of the parent material can be performed to improve characteristics of the joined assembly. For example, joined MgO or joined sapphire can be treated in an oxygen atmosphere. The additional heat treatment induces further reaction and diffusion of the joining agent (metal or oxide) that could reside in the joined interface. The additional heat-treatment is performed at a temperature in a range of 500˜2,000° C. for 5˜10 hours.

Hereinafter, practical examples performed to demonstrate the validity of the present invention will be described. The following experiments should not be construed as limiting the scope of the present invention. The practical examples concern the joining of ceramic materials such as sapphire crystals, and various modifications thereto can be made. For example, different impositions and crystal structures such as single crystals, poly-crystals, and amorphous materials can be joined.

### MODE FOR INVENTION

### EXAMPLE 1

### Sapphire Joining-1

A white sapphire was cut to have a desired crystallographic orientation, size, and shape, and the cut surfaces were polished by sequentially using diamond abrasives from 6 μm to 1 μm. The sapphire was cut in a disc shape with a thickness of 5 mm. A pure Al (99.9%) layer having a thickness of 2-4 μm was then deposited on the polished sapphire surface using a vacuum evaporator.

The deposited surfaces were then arranged to face each other, and heat-treated in a vacuum furnace or a hot press furnace. The heat treatment was performed at temperature in a range of 1,000-1,850° C. for 30 minutes to 2 hours under a pressure in a range of 0-30 MPa in the presence of argon gas. The temperature was increased at a rate of 10° C. per minute until 1,500° C., and at a rate of 5° C. per minute above this temperature. The heat treatment atmosphere can be performed in a vacuum state, or a gas containing hydrogen or oxygen can be used instead of argon. To increase optical transparency, if necessary, a second heat treatment at a temperature in a range of 1,000-2,000° C. for 30 minute to 10 hours under an oxygen atmosphere can be performed.

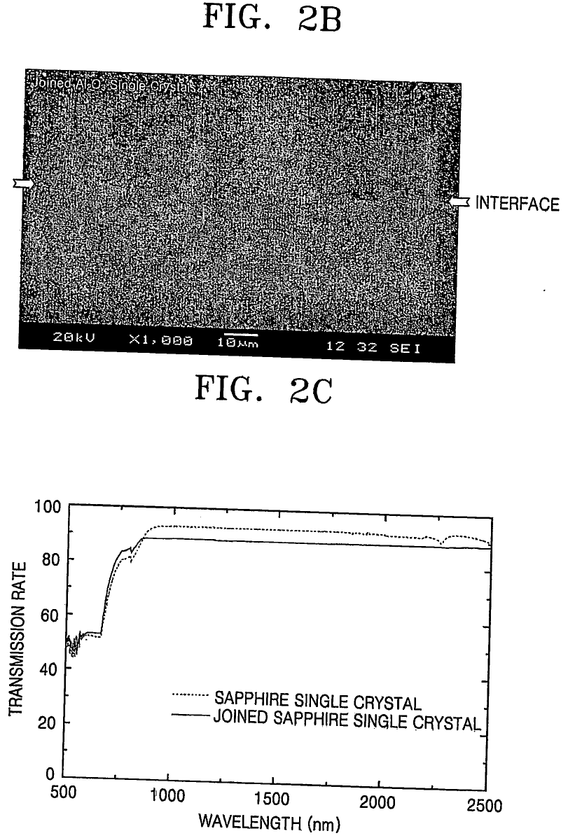

FIG. 2A is a photograph of the sapphire crystals joined using Al as a joining agent.

The crystal, a joined sapphire crystal, exhibits a uniform and good optical transmittance as can be seen in this figure, and an excellent joint strength (about 300 MPa).

FIG. 2B is a magnified SEM (Scanning Electron Microscopy) image of the interface region of the sapphire crystals shown in FIG. 2A Referring to FIG. 2B, no second phase, i.e., a metallic or oxide phase, is observed at the interface. Thus, the deposited Al film was completely transformed into a sapphire crystal through a series of processes such as melting the joining agent, wetting the parent materials with the molten agent, smoothening asperities of the joined surfaces by a solution and re-precipitation process, oxidizing the molten agent, and incorporating the oxidized molecules to the parent materials, during the heat treatment. As a result, as shown in

FIG. 2C, good optical transmittance of the joined sapphire crystals (solid line), which is comparable to that of a single crystal sapphire (dotted line), was obtained.

Optical transmittance of the joined sapphire crystals was obtained when the joining agent material selected from the group consisting of not only Al, but also Al alloys, Mg, Cr, Ti, Fe, V, Si, Ca, GO, Cu, Ag, Bi, Cd, Ce, Ga, Hf, K, La, Mn, Na, Nb, Nd, Ni, Pb, Sc, Sm, Sn, Sr, Ta, U, Y, Zn, Zr, Li and alloys of these metals were used.

### EXAMPLE 2

### Sapphire Joining-2

The second experiment was carried out under the same conditions as in Example 1, but an Al foil having a thickness of approximately 18 μm was inserted between the two polished surfaces instead of depositing an Al film. The pieces were heat-treated in a vacuum furnace or a hot press furnace. The heat treatment was performed at a temperature in a range of 600-1,850° C. under a pressure in a range of 0-30 MPa for 30 minute to 2 hours in the presence of argon gas. The remaining processes were the same in Example 1.

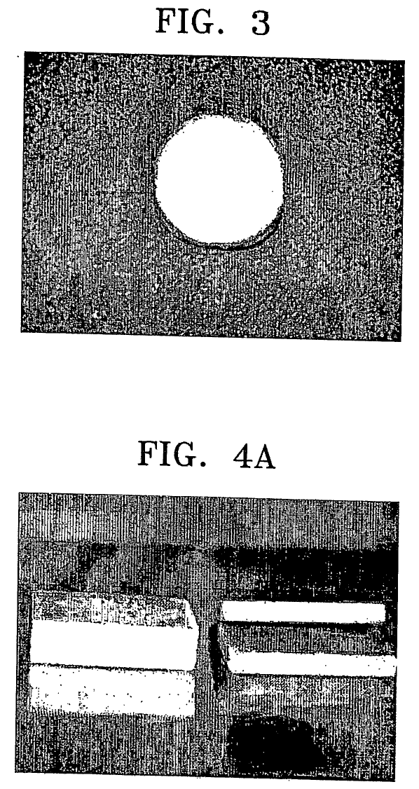

FIG. 3 is a photograph of the sapphire crystals joined in this second example using an Al foil. Referring to FIG. 3, the joined sapphire crystals have a strong joint strength and uniform characteristics.

### EXAMPLE 3

### Joining Al₂O₃ Ceramics

Poly-crystalline alumina pieces were prepared by sintering alumina (Al₂O₃) powder (AKP-50, Sumitomo, Japan) at 1,400° C. in a hot press furnace, and Al, as a joining agent, was deposited on the surfaces to be joined.

The pieces were arranged so that the to-be-joined surfaces faced each other and were heat-treated under the same conditions as in Example 1. The heat treatment was carried out at a temperature in a range of 1,000-1,850° C. for 30 minutes to 2 hours under a pressure in a range of 0-30 MPa in the presence of argon gas. The remaining steps were the same as in Example 1. The heat treatment can be performed in a vacuum state, or in the presence of a gas containing hydrogen or oxygen instead of argon.

FIG. 4A is a photograph of Al₂O₃ ceramics joined in this example. FIG. 4B is a magnified SEM image of the interface region of the joined Al₂O₃ ceramics in FIG. 4A As seen in FIG. 4B, when Al was used as a joining agent, the joined Al₂O₃ ceramics had a strong joint strength and uniform characteristics without a second phase at the interface. This is because, as explained earlier, all deposited Al film was transformed into Al₂O₃ crystal through a previously mentioned series of processes occurring during the heat treatment.

The metallic elements for joining alumina can be selected from the group consisting of Al, Mg, Cr, Ti, Fe, V, Si, Ca, Co, Cu, Ag, Bi, Cd, Ce, Ga, Hf, K, La, Mn, Na, Nb, Nd, Ni, Pb, Sc, Sn, Sn, Sr, Ta, U, Y, Zn, Zr, Li, and an alloy of these metals.

### EXAMPLE 4

### MgO Single Crystal Joining

Two pieces of MgO single crystal were cut in a rectangular shape having thicknesses of 5 mm. A cut surface of each piece was sequentially polished using diamond pastes having grain sizes decreasing from 6 μm to 1 μm. Then, pure Mg (99.99%) was deposited on the polished surface of the MgO single crystal piece to form a thin film layer with a thickness of 2-5 μm using a vacuum evaporator.

After arranging the surface of one MgO single crystal on which the Mg film was deposited and a surface of another MgO single crystal on which nothing was deposited to face each other, the combined pieces were heat-treated in a vacuum furnace or a hot press furnace. The heat treatment was carried out at a temperature in a range of 500-1,850° C. for 30 minutes to 2 hours under a pressure in a range of 0-30 MPa in the presence of argon gas. The remaining steps were the same as in Example 1.

It was found that light transparency could be improved when a second heat treatment was performed at a temperature in a range of 500-2,000° C. for 5 minutes to 10 hours. Heat treatment plays a very important role for light transparency of the joined MgO single crystals because the phase change, diffusion, oxidation, or incorporation of the deposited thin Mg film is very sensitive to the heat treatment conditions.

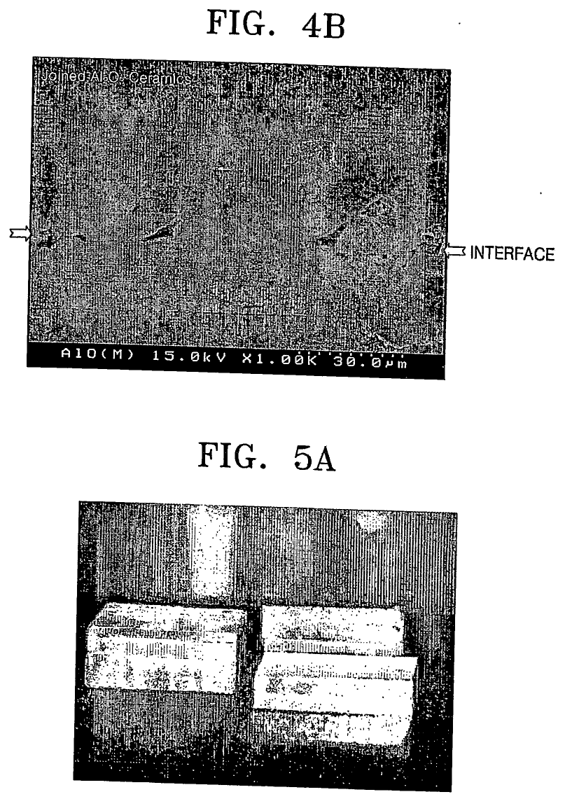

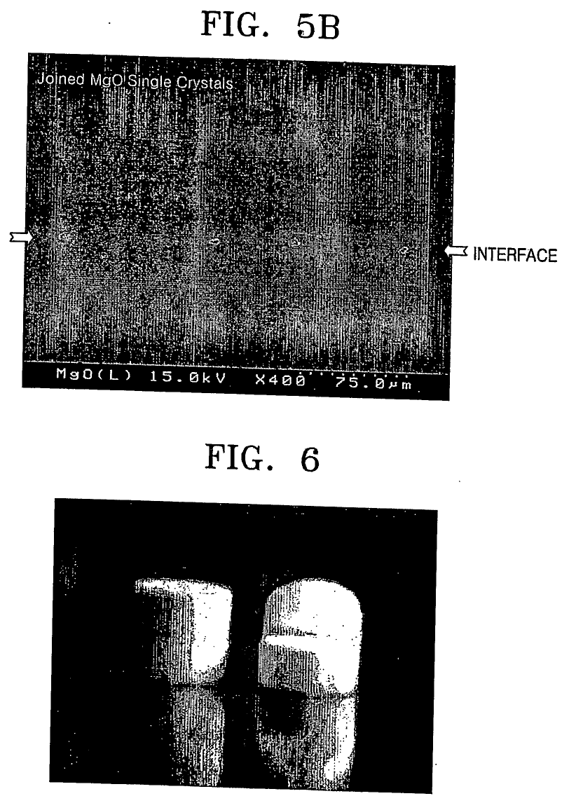

FIG. 5A is a photograph of the MgO single crystals joined using Mg thin film layer deposited in this example. FIG. 5B is a magnified SEM image of the interface region of the joined MgO single crystals shown in FIG. 5A As seen in FIG. 5A, when the Mg film was deposited, MgO single crystals having a strong joint strength and uniform characteristics without a second phase at the interface is obtained.

The same result can be obtained when a metallic element for joining agent material selected from the group consisting of not only Mg, but also Mg alloy, Li, Be, Na, Al, K, Ca, Ti, Zn, Cs, Ba, B, Cu, Ga, Ge, Se, Rb, Sr, Ag, In, Sn, Sb, Te, La, Tl, Pb, Bi, Ce, Si, Cr, Mn, Fe, Co, Ni, Y, Yb, Sc, V, Er, Zr, Nb, and alloys of these metals is used.

### EXAMPLE 5

### Joining ZnS

Surfaces of two poly-crystalline ZnS pieces, each with a disc shape, were ground, and a pure Zn (99.99%) film having a thickness of 2-5 μm was deposited on each surface of the ZnS using a vacuum evaporator.

The ZnS pieces were arranged such that surfaces on which Zn was deposited faced each other, and the combined pieces were thermally treated in a vacuum furnace or a hot press furnace. The heat treatment was carried out at a temperature in a range of 500-1,000° C. for 30 minutes to 2 hours under a pressure in a range of 0-10 MPa in the presence of argon gas. The temperature was raised at a rate of 10° C. per minute.

FIG. 6 is a photograph of the ZnS materials joined using a thin film layer of Zn. As seen in FIG. 6, when a Zn film was deposited, the joined ZnS crystals having a strong joint strength and uniform quality without a second phase in the bonding interface are observed. This is because, as explained earlier, all deposited Zn film was transformed into ZnS through a series of processes such as melting the joining agent, wetting the parent materials with the molten agent, smoothening asperities of the joined surfaces by a solution and re-precipitation process, sulfurating the molten agent, and incorporating the sulfurated molecules to the parent materials, during the heat treatment.

For joining ZnS poly-crystals, in addition to Zn, a metallic element selected from the group consisting of Li, Be, Na, Mg, Al, K, Ca, Ti, Cs, Ba, B, Cu, Ga, Ge, Se, Rb, Sr, Ag, In, Sn, Sb, Te, La, Tl, Pb, Bi, Ce, Si, Cr, Mn, Fe, Co, Ni, Y, Zr and alloys of these metals can be used.

### EXAMPLE 6

### Joining Amorphous Soda-Lime Glass

A pure Al (99.99%) film having a thickness in a range of 2-5 μm was deposited on a cutting surface of a rectangular shaped soda-lime glass piece using a vacuum evaporator. Additionally, a rectangular shaped soda-lime glass piece without a thin Al film layer was prepared.

The soda-lime glass pieces were then arranged such that the surface on which Al was deposited and the surface without an Al film faced each other, and the combined pieces were heat-treated in a vacuum furnace or a hot press furnace. The heat treatment was carried out at a temperature in a range of 400-700° C. for 30 minutes to 2 hours under an applied pressure in a range of 0-10 MPa in the presence of argon gas. If necessary, the heat treatment may be performed in air or in a vacuum or in the presence of an inert gas, a hydrogen-containing gas, or a gas containing a non-metallic element constituting soda-line glass. For improved light transparency, a second heat treatment at a temperature in a range of 400-700° C. for 5 minutes to 10 hours can be performed.

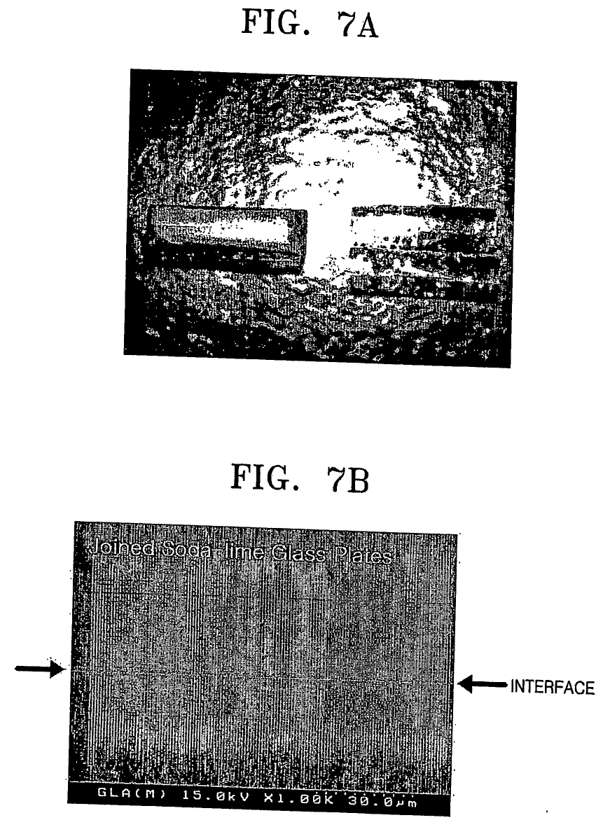

FIG. 7A is a photograph of the joined soda-lime glass structure using an Al deposition film. FIG. 7B is a magnified SEM image of a bonding interface of the joined soda-lime glass structure in FIG. 7A As seen in FIG. 7A, when Al was deposited, the joined soda-lime glass has a strongly bonded joint and uniform quality without a second phase in the bonding interface. This is because all deposited Al film was transformed into soda-lime glass through a series of processes similar to those mentioned in Example 1 during heat treatment.

For bonding soda-lime glass, a metallic element selected from the group consisting of not only Al, but also an Al alloy, Li, Be, Na, Mg, K, Ca, Ti, Zn, Cs, Ba, B, Cu, Ga, Ge, Se, Rb, Sr, Ag, In, Sn, Sb, Te, La, Tl, Pb, Bi, Ce, Si, Cr, Mn, Fe, Co, N, Y, Zr, Nb, and alloys of these metals can be used.

### EXAMPLE 7

### Joining AlN Ceramics

For joining aluminum nitride (AlN), two pieces of AlN ceramics manufactured in a hot press furnace were prepared. One surface of each piece was ground to flatten its surface. A pure Al (99.99%) film with a thickness of 2-4 μm was deposited on the surface of one of the AlN piece using a vacuum evaporator.

The two pieces were arranged such that the surface deposited with Al of one piece faced the surface without an Al film of another piece, and the combined pieces were heat-treated in a vacuum furnace or a hot press furnace. The heat treatment was carried out at a temperature in a range of 1,000-1,850° C. for 30 minutes to 2 hours under a pressure in a range of 0-30 MPa with a voltage of 0-0.5 KV applied to the two pieces in the presence of nitrogen gas. The temperature was increased at a rate of 10° C. per minute until 1,500° C., and at a rate of 5° C. per minute above this temperature. If necessary, the heat treatment can be performed in a vacuum state, or in the presence of an inert gas, a hydrogen-containing gas, or a gas containing oxygen. For improved properties, if necessary, a second heat treatment at temperature in a range of 1,000-2,000° C. for 30 minutes to 10 hours can be performed in a nitrogen-containing atmosphere.

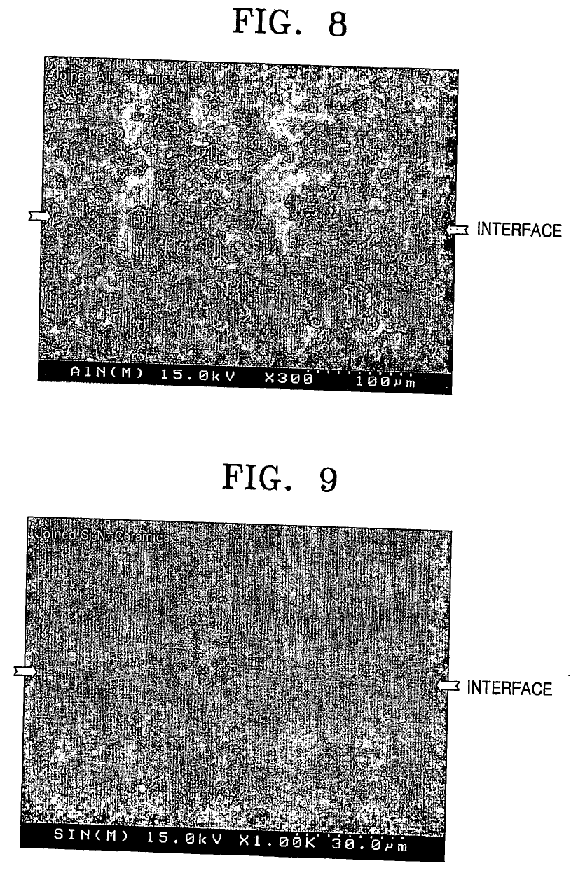

FIG. 8 is an SEM image of the interface region of the joined AlN ceramics and illustrates a strong joint formed and there is no second phase between the two joined AlN ceramics. This is because, as explained earlier, all deposited Al film was transformed into AlN through a series of processes such as melting the joining agent, wetting the parent materials with the molten agent, smoothening asperities of the joined surfaces by a solution and re-precipitation process, nitriding the molten agent, and incorporating the nitride molecules to the parent materials, during the heat treatment.

For joining AlN, a metallic element selected from the group consisting of not only Al, but also an Al alloy, Li, Be, Na, Mg, K, Ca, Ti, Zn, Cs, Ba, B, Cu, Ga, Ge, Se, Rb, Sr, Ag, In, Sn, Sb, Te, La, TI, Pb, Bi, Ce, Si, Cr, Mn, Fe, Co, Ni, Y, Zr, M, Mo and alloys of these metals can be used.

### EXAMPLE 8

### Joining Si₃N₄ Ceramics

To join silicon nitride (Si₃N₄), two pieces of Si₃N₄ ceramics manufactured in a hot press furnace were prepared. One surface of each piece was ground to flatten its surface. A pure Si (99.99%) film with a thickness of 2-4 μm was deposited on the surface of one of the Si₃N₄ pieces using a vacuum evaporator. The remaining steps were the same as in Example 7.

FIG. 9 is an SEM image of the interface region of the joined Si₃N₄ ceramics and illustrates a strong joint formed and there is no second phase between the two joined Si₃N₄ ceramics. The SEM image also indicates that, as explained earlier, all deposited Si was transformed into Si₃N₄.

For joining Si₃N₄, a metallic element selected from the group consisting of not only Si, but also Li, Be, Na, Mg, Al, K, Ca, Ti, Zn, Cs, Ba, B, Cu, Ga, Ge, Se, Rb, Sr, Ag, In, Sn, Sb, Te, La, Ti, Pb, Bi, Ce, Cr, Mn, Fe, Co, Ni, Y, Zr, Nb, Mo, Sc, V, Tc, Ru, Rh, Hf, Ta, W, Re, Os, Ir, TI, Po, Fr, Ra, Pr, Nd, Pm, Sm, Eu, Gd, Tb, Dy, Ho, Er, Tm, Yb, Lu, Ac, Th, Pa, U, Np, Pu and alloys of these materials can be used.

### EXAMPLE 9

### Joining SiC Ceramics

To join SiC, two pieces of SiC ceramics manufactured in a hot press furnace were prepared, and Si or Si and C was deposited after grinding a surface of one of the SiC pieces. The pieces were heat-treated at temperature of 1,600-1800° C. under a pressure in a range of 0-30 MPa in the presence of methane (CH₄) for 2 hours.

A pure Si film with a thickness of 2-4 μm was deposited on the surface of one of the SiC pieces using a vacuum evaporator. The remaining steps were the same as in Example 7 that the heat-treatment was conducted in the presence of methane (CH₄).

FIG. 10 is a SEM image of the interface region of the joined SC ceramics and shows a strong joint (around 400 MPa) without a second phase. This is because the deposited 5 was transformed into SiC through a series of processes similar to those mentioned previously during heat treatment.

For joining SiC, as in the case of bonding the Si₃N₄ poly-crystal, a metallic element selected from the group consisting of not only Si, but also C, Li, Be, Na, Mg, Al, K, Ca, Ti, Zn, Cs, Ba, B, Cu, Ga, Ge, Se, Rb, Sr, Ag, In, Sn, Sb, Te, La, Tl, Pb, Bi, Ce, Cr, Mn, Fe, Co, N, Y, Zr, Nb, Mo, Sc, V, Tc, Ru, Rh, Hf, Ta, W, Re, Os, Ir, Tl, Po, Fr, Ra, Pr, Nd, Pm, Sm, Eu, Gd, Tb, Dy, Ho, Er, Tm Yb, Lu, Ac, Th, Pa, U, Np, Pu, and alloys of these materials can be used.

### EXAMPLE 10

### Joining Amorphous Quartz Glass

For joining quartz glass, two pieces of rectangular shaped quartz glass were prepared. A pure Si film with a thickness of 2-5 μm was deposited on the quartz glass surfaces to be joined by a vacuum evaporator.

The two pieces were arranged such that the surface of one of the pieces on which Si was deposited faced the surface of the other piece on which a Si film was not deposited, and the combined pieces were heat-treated in a vacuum furnace or a hot press furnace. The heat treatment was carried out at a temperature in a range of 800-1,500° C. for 30 minutes to 2 hours under a pressure in a range of 0-10 MPa with a voltage of 0-0.5 KV applied thereto the combined pieces in the presence of oxygen. If necessary, the heat treatment can be performed in a vacuum state, or in the presence of an inert gas or a hydrogen-containing gas. If necessary, a second heat treatment at temperature in a range of 500-1,500° C. for 5 minutes to 10 hours can be performed in a gas containing a non-metallic element constituting quartz glass.

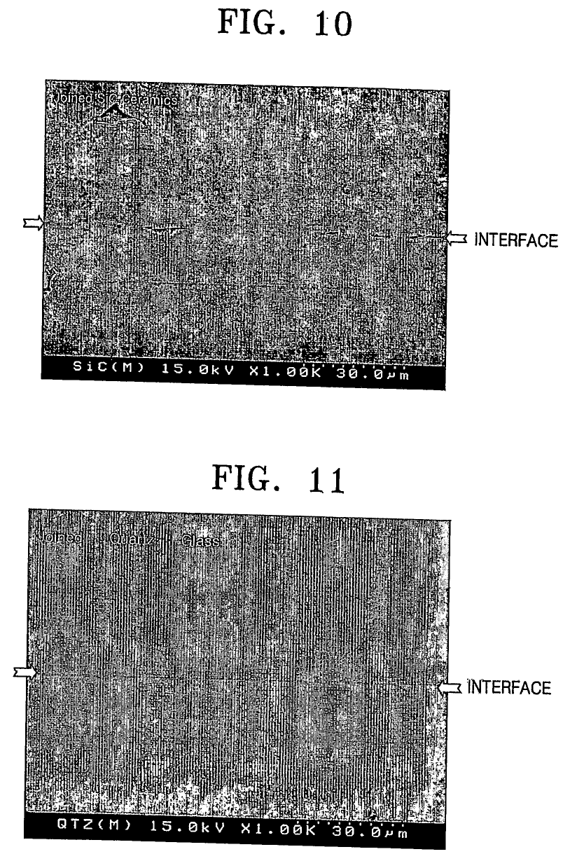

FIG. 11 is a SEM image of the interface region of the joined quartz glass and illustrates no second phase at the joined interface. This is because the deposited Si was transformed into quartz glass through a series of the processes mentioned previously during heat treatment.

For joining quartz glass, a material selected from the group consisting of not only Si, but also Li, Be, Na, Mg, Al, K, Ca, Ti, Zn, Cs, Ba, B, Cu, Ga, Ge, Se, Rb, Sr, Ag, In, Sn, Sb, Te, La, Tl, Pb, Bi, Ce, Cr, Mn, Fe, Co, Ni, Y, Zr, Nb, and alloys of these materials can be used.

The method of joining compound material according to an embodiment of the present invention can solve the conventional drawbacks of low joint strength, degradation of characteristics such as reductions in optical transparency, and in chemical and thermal stabilities, all of which are due to the characteristics difference between the parent material (compound material) and the second phase (intermediate layer phases). Thus, the reaction diffusion bonding technology enables the easy manufacturing of monolithic ceramic parts that cannot be produced by conventional technologies with a high yield, thereby reducing manufacturing costs.

While this invention has been particularly shown and described with reference to exemplary embodiments thereof, it will be understood by those skilled in the art that various changes in form and details may be made therein without departing frcm the spirit and scope of the invention as defined by the appended claims.

### INDUSTRIAL APPLICABILITY

As described above, the method of joining ceramic materials according to embodiments of the present invention provides a method of manufacturing monolithic ceramic parts of large size and complicated shape without the disadvantages of conventional joining methods. That is, the reaction diffusion-bonding method solves problems of weak joint strength, particularly at high temperatures, and degradation of thermal, chemical, optical, and electrical and electronic characteristics of the ceramic parts joined by conventional methods. The present invention enables the production of joined structures of ceramic crystals, composites, solid solutions, or amorphous materials without using particularly expensive equipment, thereby reducing manufacturing costs.

The method of joining ceramic materials according to an embodiment of the present invention can be applied to various fields of applications which require the joining of ceramic materials. Particularly, the method could be useful for manufacturing ceramic components for semiconductor processing, in which the purity and the chemical stability of the components are extremely important, such as ceramic electrostatic chucks, heaters, and jigs. Production of large area wafers for which large-sized ingots are currently not available is another possible application of the present invention. The large-sized ingots could be produced by joining small-sized ingots available for wafers. Furthermore, small pieces of natural gems can be joined into a large-sized crystal gem.

1. A method of joining compound materials, including ceramics, the method comprising:
grinding, lapping, or polishing entire or portions of surfaces to be joined of two or more pieces of a compound material;
forming a thin film of a joining agent on one or more of the ground, lapped, or polished surfaces by one of inserting, spreading, depositing, plating, and coating, the joining agent being able to transform into the compound material by being incorporated into the compound material or by forming a solid solution with the compound material upon heat treating; and
forming a directly bonded interface without a second phase by heat treating the pieces of the compound material with the to-be-joined surfaces on which the joining agent film is formed arranged to face each other,
wherein the joining agent thin film is composed of a material selected from the group consisting of metals, metal organics, and metal compounds.

2. The method of claim 1, wherein, during the heat-treatment, the joining agent is incorporated into the compound material by a chemical reaction between the joining agent and the parent compound material and/or an atmosphere gas.

3. The method of claim 1 further comprising, after forming the directly bonded interface, second heat treating joined compound materials in air, in a vacuum or in the presence of one selected from the group consisting of an inert gas, a hydrogen-containing gas, and a gas containing a non-metallic element constituting the compound material.

4. The method of claim 3, wherein the second heat treatment is performed at a temperature between room temperature and the melting point of the compound material for 1 minute to 10 hours.

5. The method of claim 1 further comprising, after forming the joining agent thin film, heat treating the agent film at a temperature below the agent film's melting point in air or in a vacuum, or in the presence of an inert gas, a hydrogen-containing gas, or a gas containing a non-metallic element constituting the compound material.

6. The method of claim 1, wherein an electric field is applied to the pieces of compound material being bonded during the heat treatment for forming the directly bonded interface.

7. The method of claim 1, wherein pressure is applied to the pieces of compound material being bonded during the heat treatment for forming the directly bonded interface.

8. The method of claim 1, wherein the heat treatment for forming the directly bonded interface is performed under a pressure in a range of 0-100 MPa.

9. The method of claim 1, wherein the heat treatment for forming the directly bonded interface is performed in air or in a vacuum or in the presence of an inert gas, a hydrogen-containing gas, or a gas containing a non-metallic element constituting the compound material.

10. The method of claim 1, wherein the heat treatment for forming the directly bonded interface is performed at a temperature in a range between the melting point and the boiling temperature of the joining agent for about 1 minute to 10 hours, wherein the melting point may refer to the temperature at which the joining agent melts partially.

11. The method of claim 1, wherein the thickness of the joining agent thin film is in a range of approximately 0.001˜500 μm.

12. The method of claim 1, wherein the heat treatment for forming the directly bonded interface comprises:
forming a thin liquid film in the interface region between the pieces of the compound material being bonded, thereby facilitating migration of material in the interface by heating the joining agent above the melting point, which may refers to a partial-melting point, of the joining agent; and
chemically reacting the joining agent with the parent material and/or the non-metallic element constituting the parent material supplied from the atmosphere gas to incorporate the joining agent into the parent compound material.

13. A method of joining compound single crystal materials comprising:
(a) grinding, lapping, or polishing entire or portions of surfaces to be joined of two or more pieces of a single crystal or a solid solution single crystal;
(b) forming a joining agent thin film having a thickness in a range of 0.001-500 μm by one of inserting, spreading, depositing, plating, and coating on more than one surfaces of the pieces to be joined, the joining agent containing a metallic element that can be incorporated into the parent single crystal upon heat treating;
(c) arranging the pieces of the single crystal or solid solution single crystal such that surfaces thereof on which the joining agent thin films are formed face each other; and
(d) forming a directly bonded interface without a second phase by heat treating the pieces at a temperature between the melting point, which nay be a partial-melting point, and the boiling point of the joining agent for approximately 1 minute to 10 hours in air or in a vacuum, or in the presence of an inert gas, a hydrogen-containing gas, or a gas containing a non-metallic element constituting the single crystal being bonded.
